(19) United States
(12) Patent Application Publication
(10) Pub. No.: US 2020/0313855 A1
(43) Pub. Date: Oct. 1, 2020

(54) CONSENSUS METHOD FOR BLOCKCHAIN VIA VIRTUAL MACHINE BASED HYBRID DELEGATED PROOF OF STAKE AND PROOF OF WORK (VDPOSW)

(71) Applicant: S, Sunnyvale, CA (US)

(72) Inventor: Si Yin, Sunnyvale, CA (US)

(73) Assignee: Si Yin, Sunnyvale, CA (US)

(21) Appl. No.: 16/365,670

(22) Filed: Mar. 26, 2019

(51) Int. Cl. H04L 9/06; G06F 9/455

(52) U.S. Cl. CPC H04L 9/0637; H04L 9/0643; G06F 9/45558; G06F 2009/45587; H04L 2209/38; G06F 2009/45595; H04L 2209/463

(57) ABSTRACT

New consensus methods are provided to utilize a set of virtual machines to serve as both of the mining machines as well as delegates and is achieved by a hybrid mechanism of both of the proof of work and delegated proof of stake. The present disclosure firstly labels virtual machines with different computing power into different categories and vote to elect virtual machines from each category into delegate cluster. When the transaction requests come, the transaction requests are processed in different “rounds” in the time spectrum, and in each “round”, the virtual machines of different category are given equal time windows to perform the mining work. To prevent malicious delegates' attack, the present disclosure also implements a new method to randomize the serving order of each delegate for future “round” by hashing the signature key and mod with the total number of delegates.

### RELATED APPLICATION INFORMATION

This application claims priority to provisional application Ser. No. 62/648,274 filed on Mar. 26, 2018, entitled “Consensus Method for Blockchain via Virtual MachineBased Hybrid Delegated Proof of Stake and Proof of Work (vDPoSW)”, incorporated herein by reference.

### FIELD OF TECHNOLOGY

The disclosure relates generally to computer-implemented consensus methods for blockchain. Blockchain is a continuously growing list of records, called blocks, which are linked and secured using cryptography. Blockchain is also an open, distributed ledger that can record transactions between two parties efficiently and in a verifiable and permanent way. Consensus mechanism is one of the most important aspects of any blockchain systems that solves the double spending problem, and byzantine generals problem.

### BACKGROUND

As one of the most important aspects of any blockchain systems, the consensus algorithm design is crucial to construct a robust and health blockchain ecosystem. A safe, orderly and healthy blockchain requires us to solve two fundamental problems: double spending and byzantine generals problem. Double spending problem means to reuse the currency in two transactions simultaneously. Byzantine generals problem means during the peer to peer communication of the distributed system, some maliciously users may tamper the communication contents, thus lead to security breach or communication inconsistency.

### BRIEF SUMMARY OF THE DISCLOSURE AND ITS ADVANTAGE

In order to make the whole blockchain safe and consistent, the generation of block needs to reach a certain consensus, thus the consensus algorithm is one of the keys for any blockchain technologies. The common consensus algorithms are PoW, PoS, and DPoS. PoW was described in S. Nakamoto, “Bitcoin: A peer-to-peer electronic cash system”, 2009. PoS was described in S. King and S. Nadal, “PPCoin: Peer-to-Peer Crypto-Currency with Proof-of-Stake,”, 2012. DPoS was described in Myles Snider, Kyle Samani, and Tushar Jain, “Delegated Proff of Stack: Features & Tradeoffs”.

PoW (Proof of Work): The workload proof mechanism, through a large number of HASH operations, calculates a suitable random number and produces a new block. And this is the safest way of security, but at the same time, it is also very energy consuming. Bitcoin is the most typical PoW implementation.

PoS (Proof of Stake): The ownership proof mechanism, through the holding amount and holding time of the token, reduces the difficulty of the block production. This method solves the problem of energy consumption comparing with PoW, but there are certain bottlenecks in security, and system bifurcation is easy to appear. PPCoin is one typical PoW implementation.

DPoS (Delegated Proof of Stake): The agent's equity proof mechanism, by which a certain number of agents are elected by the ballot papers, and the blocks are produced in a certain order between the agents. DPoS greatly reduces the number of verification node and improves transaction confirmation speed under the premise of security protection. However, the corresponding centralization degree is increased. BitShares is an example of DPoS.

In the original design of PoW, it is the hope of the designer that all mining workers can use the CPU to perform the mining work such that each node, even with different computing power (thus different hashing power), still has the equal opportunity to participate in the decision-making of the blockchain. However, with the development of the hardware such as GPUs and ASICs, and the aggregation of individual computing power into mining pools, the ordinary miners rarely have the opportunity to create a block. Furthermore, there are more and more criticize of PoW not being environment friendly and slowing down transaction speed on blockchain.

On the other side, the DPoS mechanism such as BitShares tries to tackle the problem of PoW by allowing each node to select the delegates based on its share stake. The top N delegates that have got the most votes have the accounting right. The sufficient decentralization is achieved as long as 50% of the voting shareholders believe their delegates are part of the delegates group that can perform the block creation and validation work. Generally, the blockchain using DPoS is more efficient and power-saving than PoW because all of the blocks creation and validation occurred only on a group of delegates. Yet, there are more and more criticize from the community that pure DPoS only represents the interest of the large shareholders, and the small and medium shareholders rarely have the rights in the block chain decision making process.

Accordingly, there exists a need for a method and apparatus to balance the pros and cons of PoW and DPoS, for a stable, robust, and efficient consensus design for any blockchain system.

The present disclosure provides computer-implemented consensus methods that utilize a set of virtual machines to serve as both of the mining machines as well as delegates and is achieve by a hybrid mechanism of both of the proof of work and delegated proof of stake. In the real world, a virtual machine is an emulation of a physical computer system, and can perform the similar functionality from both of the computer architecture and operating system level. Some VM examples are vmware vsphere VM and Microsoft Hyper-V VM. In this disclosure, the concept of Virtual Machines (VMs) is far more complex. They are multi-role entities that own the following roles: firstly, VMs are mining machines to solve the hash computing for the proof of work (PoW). Secondly, VMs are delegates that represent the share stake of the shareholders of on a particular blockchain ecosystem. Third, VMs also have the role of commodities that are tradable in the blockchain ecosystem. To start with, VMs are created by smart contacts to have different computing powers, and the total number of the VMs can be upper bounded in a given period of time based on supply and demands. Blockchain shareholders such as decentralized application developers and investors acquire the VMs with different computing power via bidding. As VMs are the only eligible miners on the blockchain ecosystem, and higher computing power represents higher voting right, shareholders are incentive to invest on VMs to achieve stable and healthy long-term growth. The total number of the VMs is adjustable from time to time base on the supply and demand. For example, if the transition fees are high for a given period of time, which indicates the demand is higher than the supply, more VMs will be created in the next period of time and released into the blockchain ecosystem to create more supply to reduce the high transaction fee.

The present disclosure firstly labels virtual machines with different computing power into different categories and vote to elect virtual machines from each category into delegate cluster. When the transaction requests come, the transaction requests are processed in different “rounds” in the time spectrum, and in each “round”, the virtual machines of different category are given equal time windows to perform the mining work. To prevent malicious delegates' attack, the present disclosure provides computer-implemented methods to randomize the serving order of each delegate for future “round” by hashing the signature key and mod with the total number of delegates.

The advantage of the present disclosure is multiple folded. First, the computer-implemented consensus methods described herein are more efficient than PoW because the disclosed methods can greatly reduce the hash complexity among trusted delegates. Secondly, the computer-implemented consensus methods described herein resolve the potential monopoly issue of DPoS because it gives the miners (virtual machines) of different computing power substantially the equal opportunity to perform mining work. At the same time, the disclosure also achieved the fairness to all delegates because the mining reward is proportional to the computing power given the same hash complexity. Third, the computer-implemented consensus methods described herein are robust to malicious user's attack because the present disclosure also uses the hash and mod operation to ensure a new the serving order of each delegate for future “round” is randomized so that one is able to predict the future serving time slot. Last but not this list, the present disclosure also creates a state space representation and validates vDPoSW is controllable.

### BRIEF DESCRIPTION OF THE DRAWINGS

FIG. 1 shows the workflow of vDPoSW, according to one embodiment.

FIG. 2 illustrates the signature and ordering of vDPoSW, according to one embodiment.

### DETAILED DESCRIPTION

vDPoSW Workflow:

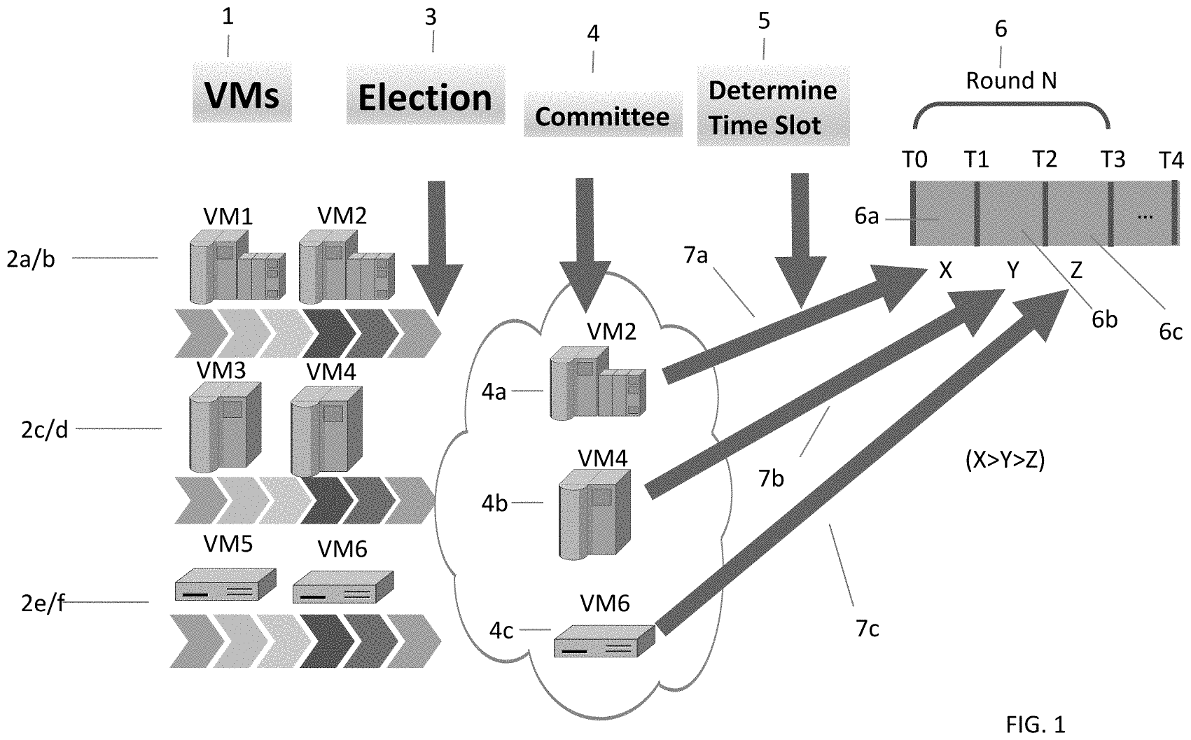

Referring now to the disclosure in more detail, in FIG. 1, shows the workflow of vDPoSW, which is composes of three steps: a) virtual machine election; b) determine the time slot; and c) serve the transaction requests.

a. Virtual Machines election: First, anyone can acquire a VM to participate the election. For better illustration, we simplify the model to assume there are only three types of VMs: gold (large computing power, 2a), silver (medium computing power, 2b), and bronze (small computing power, 2c). The computing power of each type is designed such that gold>silver>bronze, i.e.,

VM₂^{gold}>VM₄^{silver}>VM₆^{bronze} (1)

Let's further assume the virtual machines VM1/2 2a/b, VM3/4 2c/d, and VM5/6 2e/f belong to gold, silver, and bronze respectively. Right after VMs are created, VMs 2a/b, 2c/d, and 2e/f are put into the queue pool as the delegate candidate.

Sequentially, when the new transaction requests come, the election 3 is triggered to choose which VMs are selected to be the delegates. In our scenario, let's assume VM2 4a of gold type, VM4 4b of silver type, and VM6 4c of bronze type are selected as delegates and they form a committee 4, and they fulfill the requirements that

VM₂^{gold}+VM₄^{silver}+VM₆^{bronze}≥50% VotingPower (2)

b. Determine time slot 5: In vDPoSW, the transaction requests are processed in different “rounds” in the time spectrum, and in each “round” 6, the hash difficulty is the same for all delegates. To ensure delegates from each category has the fair opportunity to participate the mining, we implement the rules as below:
1) In each given round, a VM from each category will participate the mining process and has equal time windows. In our case, the VM2 of gold type 4a, VM4 of silver type 4b, and VM6 from bronze type 4c will all included in round N;
2) To prevent delegates of a particular category from monopolizing the mining process, we will limit min and max percentage of delegates from each category in any given round N;
3) In case there is no delegate of a particular category from the delegate cluster for any given time round N, the empty time window will be evenly distributed among delegates from other categories.
   In our case, as illustrated in FIG. 1, the round N 6 starts at T0, and is expected to end at T3. The total time in round N, ΔT=T3−T0, is equally divided into K slides, where K is the total number of delegates in the delegates cluster, i.e.,

T1−T0=T2−T1=T3−T2=ΔT/3 (3)

Let's assume VM2 in gold 4a type starts to serve the transaction request at T0 and stopped at T1 (the order may be different, and we will address the ordering later). Within ΔT/3 time frame, VM2 processed X 6a number of transaction requests. Same scenario applies to VM4 and VM6 at T1 and T2, and each processed Y 6b and Z 6c number of transaction requests within ΔT/3 time frame. Recall in terms of computing power, we have (1), and the hash difficulty is the same for all delegates in round N, thus we will have

X>Y>Z (4)

We can see from eq. (3) that vDPoSW gives each delegate an equal opportunity to participate the mining process regardless the computing power of the delegates. On the other hand, eq. (4) shows that the delegate with higher computing power will process more transaction requests (thus more blocks) and thus generate more rewards for the shareholder with higher share stake, even it was only given same process time comparing with other delegates with lower computing power. In reality, we will put more constraints to ensure a sophisticated delegates system. For example, we may set the upper bound for the percentage of VMs in each category.

The Signature and Ordering of vDPoSW:

The design goal of the signature and random ordering is to ensure a given delegate VM in the committee 4 can only process transaction request in the assigned “round” as well as the assigned time window, so that any malicious user cannot “guess” what is the ordering number of the a particular delegate, to prevent intended attack.

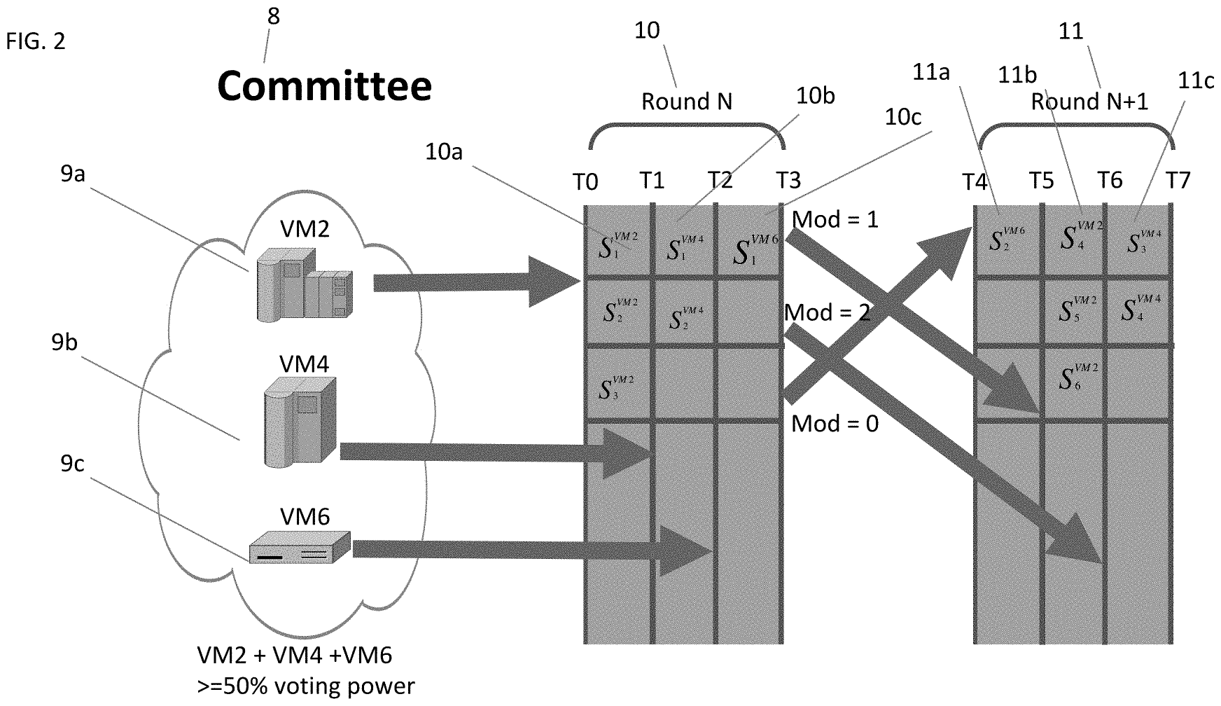

Referring now to the disclosure in more detail, in FIG. 2, assume in round N, VM2 9a starts to perform the mining and create a new block at T0, we add a private key into the optional filed of the block and got a signature S₁^{VM2} by performing a hash operation:

S₁^{VM2}=Hash(K₁^{VM2}) (5)

Where K₁^{VM2} is the private key value for the 1^{st} block created by VM2 in the round N 10. Similarly, when VM2 9b creates the 2^{nd} and 3^{rd} block, the signature S₂^{VM3} and S₃^{VM3} are calculated by

S₂^{VM3}=Hash(K₂^{VM2}+S₁^{VM3}) (6)

S₃^{VM3}=Hash(K₃^{VM2}+S₂^{VM3}) (7)

respectively. Once VM2 9a creates its 3^{rd} block, VM2 9a determines this is the last block it can process, it then broadcast the signature S₃^{VM3} to all other VM delegates, before T2.

Sequentially, VM4 9b and VM6 9c will be the second and third VMs to follow similar procedure to create their blocks and perform the signature broadcast at the end of their last block mining. In our case, S₁^{VM6} 10c between T2 and T3, is the last signature in round N 10, and is the proof needed by each VM delegate to participate mining in the next round N+1 11. Image a malicious delegate tries to cheat the system by performing mining before round N 10 finish and try to work on round N+1 11. Its mining of new block(s) will be rejected because it will not have the final signature S₁^{VM6} to sign the newly created block.

In round N+1, we can generalize eq. (5)-(7) as below:

$$S ( n + 1 ) = Hash ( K ( n ) + {\sum }_{i = 1}^{k} {S}^{VMi} ( n ) ) \qquad ( 8 )$$

Where K(n) is the key value at round N+1, and

$${\sum }_{i = 1}^{k} {S}^{VMi} ( n )$$

is the sum of the hash value of K number of VM delegate in the previous round (for example, we have K=3 in round N).

In addition, we use the following mechanism to determine the order of VM delegate in round N+1:

O(n+1)=S(n)mod(M) (9)

Where S(n) is the signature of the last block in round N (i.e., S₁^{VM6} in our example) and M is the number of VM delegates. The mod operation will determine the serving order of each VM delegate in round N+1 11. In our case, in N+1 11, the mod result for VM2 9a, VM4 9b , and VM6 9c are 1, 0, and 2. Thus VM6 9c is scheduled to start to create block first at time stamp T4, followed by VM2 (3 blocks starting at T5), and VM4 (2 blocks starting at T6).

If there is conflict during the mod operation, we point the VM delegate to the next available slot. In case a particular VM delegate is not able to generate block in its given time windows, we will use the signature in the previous broadcast.

The Controllability Analysis of vDPoSW:

As pointed out in Gavin Wood, “Ethereum: A secure decentralized generalized transaction ledger EIP-150 revision”, in PoW, the expected time to calculate a correct “nonce” is proportional the hash difficulty. i.e., the nonce Hₘ must satisfy the relations:

$$n \leq \frac{{2}^{256}}{{H}_{d}} ⋀ m = {H}_{m} \\ With ( n , m ) = PoW ( , {H}_{n} , d ) . \qquad ( 10 )$$

Where n is the mix-hash and m is the pseudo-random number cryptographically depend on H and d. [symbol] is the new block's header H without the nonce and mix-hash components, and d is the current data set. PoW is the proof of work function. Eq.5 is the foundation of the security of the blockchain and is the fundamental reason why a malicious node cannot propagate newly create blocks that would otherwise overwrite history. In vDPoSW, however, we may choose to set the hash difficulty lower so that even the VM with lowest computing power can finish the hash computing quickly and can generate new block and process transactions in its given time window. While this design significantly increases the efficiency of the eco-system, it may increase the security vulnerability as malicious users may take advantage of the lower hash difficulty. This requires us to add additional security mechanism, namely, signature and random ordering, to safeguard a healthy blockchain ecosystem.

In any system design, the controllability is the most important aspect to inspect. The consensus algorithm design is not an exception.

By “controllable”, we mean to evaluate whether vDPoSW consensus algorithm can be properly managed even with heavy transaction requests from the main chain and side chain, and whether disclosure can steer the resource efficiency over blockchain eco-system from any initial value to the optimum state within a limited time window. This kind of controllability property is a crucial to achieve queue stabilization, delay bounds, and optimal resource control.

Assume

$$\begin{matrix}f ( K , S ( n ) ) = Hash ( K + {\sum }_{i = 1}^{k} {S}^{VMi} ( n ) ) & ( 11 ) \\ g ( S ( n ) , M ) = S ( n ) mod ( M ) \\ Eq . ( 9 ) and ( 10 ) yields & ( 12 ) \\ S ( n + 1 ) = f ( K , S ( n ) ) & ( 13 ) \\ O ( n + 1 ) = g ( S ( n ) , M ) & ( 14 )\end{matrix}$$

Eqs. (13) and (14) describe a non-linear discrete system, where the state vector x(n)=[s(n),o(n)]^{T} represents the array of signature hash value and the ordering of the VM delegate. The input vector u(n)=[K,M]^{T} represents the array of the key value and the number of VM delegates. The linearization is necessary to analyze the controllability, as was described in Z. Bubnicki, “Modern control theory”, Spring Berlin Heidelberg New York 2005. Assume the equilibrium point is (s(n)ₒ·o(n)ₒ·Kₒ·Mₒ), all of which are positive real numbers; linearizing Eqs. (13), (14) the equilibrium point, we obtain the following linearized system in state space:

$$\begin{matrix}( \begin{matrix}δ \dot{S} ( n + 1 ) \\ δ \dot{O} ( n + 1 )\end{matrix} ) = ( \begin{matrix}\frac{\partial f}{\partial S} & \frac{\partial f}{\partial O} \\ \frac{\partial g}{\partial R} & \frac{\partial g}{\partial O}\end{matrix} ) ( \begin{matrix}δ S ( n ) \\ δ O ( n )\end{matrix} ) + ( \begin{matrix}\frac{\partial f}{\partial K} & \frac{\partial f}{\partial M} \\ \frac{\partial g}{\partial K} & \frac{\partial g}{\partial M}\end{matrix} ) ( \begin{matrix}δ K \\ δ M\end{matrix} ) \\ A = ( \begin{matrix}\frac{\partial f}{\partial S} & \frac{\partial f}{\partial O} \\ \frac{\partial g}{\partial R} & \frac{\partial g}{\partial O}\end{matrix} ) , B = ( \begin{matrix}\frac{\partial f}{\partial K} & \frac{\partial f}{\partial M} \\ \frac{\partial g}{\partial K} & \frac{\partial g}{\partial M}\end{matrix} ) , we have \\ Let & ( 15 ) \\ δ \dot{x} ( n + 1 ) = A δ x ( n ) + B δ u ( n ) & ( 16 )\end{matrix}$$

By modern control theory, the system is controllable if U=[BAB] is full row rank. As (s(n)ₒ·o(n)ₒ·Kₒ·Mₒ) are all positive real numbers, we can conclude the U=[BAB] is full row rank, and thus the vDPoSW is controllable.

What is claimed is:

1. A computer-implemented consensus method for blockchain via virtual machine based hybrid delegated proof of stake and proof of work (vDPoSW), comprising:
creating, via a plurality of virtual machines, a vDPoSW workflow;
signature and random ordering of vDPoSW;
controllability analysis of vDPoSW.

2. The method of claim 1, further comprising putting the plurality of virtual machines into a queue pool as the respective delegate candidates.

3. The method of claim 1, further comprising voting to choose one or more virtual machines from the plurality of virtual machines to be the respective delegates of the blockchain system, wherein the delegates represent more than 50% of the voting power.

4. The method of claim 1, further comprising dividing a time spectrum into N different time windows, and in each time window, giving the plurality of virtual machines from different categories the equal time windows to perform the mining work.

5. The method of claim 1, further comprising limiting delegate virtual machine in the delegate cluster to only process transaction request in the assigned “round” as well as the assigned time window.

6. The method of claim 1, further comprising: to prevent the attack from malicious delegates, performing the hash of the private key of a virtual machine in a given time window and calculating its serve order in the next time round by mod with the total number of all virtual machines in the delegates cluster, in order to guarantee randomness of the serving order for each delegate for future “round”.

7. The method of claim 1, further comprising: pointing the order of a virtual machine into the next available slot in case of mod operation conflict.

8. The method of claim 1, further comprising: in case a particular VM delegate is not able to generate block in its given time windows, using the signature in the previous broadcast instead.

9. The method of claim 1, further comprising: using state space methodology to present the vDPoSW as a non-linear discrete system, where the state vector x(n)=[s(n),o(n)]^{T} represent the array of signature hash value and the ordering of the VM delegate, wherein the input vector u(n)=[K,M]^{T} represents the array of the key value and the number of VM delegates.

10. The method of claim 1, further comprising using linearization methodology to linearize the vDPoSW state space representation as δ\dot{x}(n+1)=Aδx(n)+Bδu(n).

11. The method of claim 1, further comprising: calculating the controllability representation U=[BAB] is full row rank, and validating vDPoSW is controllable.
